(19) United States
(12) Patent Application Publication
(10) Pub. No.: US 2009/0323801 A1
(43) Pub. Date: Dec. 31, 2009

(54) IMAGE CODING METHOD IN THIN CLIENT SYSTEM AND COMPUTER READABLE MEDIUM

(75) Inventor: Chikara IMAJOU, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/487,913

(22) Filed: Jun. 19, 2009

(30) Foreign Application Priority Data
Jun. 25, 2008 (JP) 2008-166417

(51) Int. Cl. H04N 7/26; G06K 9/36; G06F 15/16

(52) U.S. Cl. 375/240.01; 382/232; 375/E07.026; 709/247

(57) ABSTRACT

A GUI operation screen emulation device generates screen data for displaying a screen based on operation information given from thin client terminal. An H.264 coding software/device, whenever receiving each frame of the screen data, stores the frame in a short-term reference frame field of a DPB, and, when the activation event is registered in a message queue, copies the frame registered latest at that point of time to a long-term reference frame field. Further, the H.264 coding software/device codes the received frame by referring to the respective frames registered in the DPB.

### CROSS-REFERENCE TO RELATED APPLICATIONS

This application is based upon and claims the benefit of prior Japanese Patent Application No. 2008-166417 filed on Jun. 25, 2008, the entire contents of which are incorporated herein by reference.

### BACKGROUND OF THE INVENTION

The present invention relates to an image coding method of coding GUI (Graphical User Interface) screen data for a client, which is generated by a server in a thin client system and to an image coding program for making a computer execute the image coding method.

Over the recent years, the thin client system has been actively developed in order to avoid a load on terminal resources and obsolescence thereof due to increases both in scale and in level of sophistication of application programs and in order to improve network security against a leakage of information through centralized management of user data by a server.

In this type of thin client system, normally a disk device of the server is stored with the application program and the user data. Then, a CPU of the server processes the user data by executing the application program on the basis of items of operation information (the information on a key input and a mouse operation) received from the terminal, and transmits, as a response, GUI screen data for displaying a GUI screen for displaying a processing result back to the terminal. It is therefore sufficient that the terminal has a function of transmitting the operation information received from an input device operated by a user to input a command etc to the server, and a function of displaying the screen on a display based on the GUI screen data transmitted back from the server.

In this type of thin client system, a scheme of getting the user to efficiently perform the operation without being aware of a sense of discomfort entails improving the response to the greatest possible degree from the server executing the process based on the application program to the terminal displaying the processing result on its screen. As a matter of course, a capacity of communication resources is limited itself, and hence the display screen data generated in the server may be compressed and thus transmitted to the terminal.

Such being the case, to the great majority of thin client systems have been applied a method of compressing and transmitting the GUI screen (data) to the terminal by use of H.264 moving picture coding defined as a moving picture coding method. Herein, the H.264 moving picture coding involves, as in the case of MPEG-4 etc defined as an existing moving picture compression method, adopting inter-frame prediction, spatial conversion, quantization, entropy coding, etc, but is an improved version in terms of compression efficiency through amelioration from the existing methods. However the coding method applied to the thin client systems is not limited to the H.264 but may be other coding method by which a reference frame which can be retained and referred for coding other frame.

One of these ameliorations is a scheme of introducing a plurality of reference frames for the inter-frame prediction. Namely, in the existing moving picture compression method, a frame, which can be designated as the reference frame in the inter-frame prediction, is fixed to the just-anterior frame of a target frame, then if, e.g., a scene change is made, the compression efficiency can not be therefore increased. However, the H.264 moving picture coding enables the plurality of reference frames to be retained as specified in Joint Video Team (JVT) of ISO/IEC MPEG & ITU-T VCEG ISO/IEC JTC1/SC29/WG11 and ITU-T SG16 Q.6. Besides, the H.264 is improved so that permanently-retainable long-term reference frames can be retained and referred to in addition to short-term reference frames to be discarded in the sequence from the oldest when number of retained frames exceeds a predetermined frame count, and hence the high-efficiency compression can be attained in a way that searches for a frame approximate to the screen (picture) after the scene change from the plurality of reference frames and refers to this approximate frame.

FIG. 11 is a conceptual diagram of the thin client system using the H.264 moving picture coding. In FIG. 11, a terminal (which will hereinafter be termed a “thin client terminal”) 100 executing a thin client program transmits items of operation information (key input information and mouse operation information) inputted from an input device to a server machine (which will hereinafter be simply referred to as a “server”) 101 executing a server program that supports a thin client service, while the server 101 executes the application program based on the received operation information, then generates GUI screen data for displaying a GUI screen showing the processing result by use of GUI operation screen emulation software 102 included in the server program (or a GUI operation screen emulation device as a hardware), and executes the H.264 moving picture coding by use of H.264 coding software 103 included similarly in the server program (or an H.264 coding device defined as a hardware encoder).

At this time, as illustrated in FIG. 12, the H.264 coding software/device 103 sequentially stores, as the short-term reference frames, the respective frames of the GUI screen data received from the GUI operation screen emulation device 102 in a short-term reference frame field in a DPB (Decoded Picture Buffer) 104 made of a temporary storage memory. When a number of the short-term reference frames stored in the DPB 104 in this way exceeds a predetermined number, the frames are discarded in the sequence from the oldest in their storage time. Further, the H.264 coding software/device 103 copies an arbitrary frame in the short-term reference frames stored in the DPB 104 as the long-term reference frame to a long-term reference frame field of the DPB 104. Thus, the long-term reference frame stored in the DPB 104 continues to be permanently retained in the DPB 104 unless intentionally discarded.

Simultaneously, the H.264 coding software/device 103 configures, on the temporary storage memory, a reference list 105 in which pointers to the respective reference frames stored in the DPB 104 are listed up with a list structure, or registers, if such a reference list 105 has already existed, the pointers to the frames newly stored in the DPB 104.

Note that the H.264 coding software/device 103 notifies an H.264 decoding software/device 106, which will be described later on, of the thin client terminal 100 of the information about whether or not any one of the short-term reference frames is copied as the long-term reference frame into the DPB 104 and contents of the reference list 105.

After making the preparations described above, the H.264 coding software/device 103 codes a frame by referring to the reference list 105 and the reference frame in the DPB 104.

A coded stream acquired by thus sequentially coding the respective frames of the GUI screen (data) is transmitted as a response to the thin client terminal 100 via a network such as a LAN (Local Area Network).

In the thin client terminal 100, the H.264 decoding software/device 106 configuring the thin client program storing the frame decoded as described later on, as the short-term reference frame in a short-term reference frame field within a DPB 107 having the same structure as the DPB 104, then copies the short-term reference frame designated by the H.264 coding software/device 103 to a long-term reference frame field in the DPB 107, and generates on the temporary storage memory a reference list 108 having contents, of which the H.264 coding software/device 103 notifies. The H.264 decoding software/device 106 thus sequentially decodes each of the frames of the GUI screen data on the basis of the coded stream received from the H.264 coding software/device 103 by referring to the DPB 107 and the reference list 108 in which the same contents as those of the server 101 are reproduced, and the moving picture of the GUI screen is displayed based on the GUI screen data on a display 109.

### SUMMARY OF THE INVENTION

By the way, there has hitherto been no rule in terms of the standards about which scene is designated and registered as the long-term reference frame in the case of employing the H.264 moving picture coding, so that there was nothing but to determine based on the image processing.

However, such image processing mostly involves a large processing load. Besides, it is highly difficult to predict which scene will again appear, and it is uncertain whether or not the coding efficiency is actually improved by use of the long-term reference frame.

Therefore, it is an object of the present invention to provide an image coding method in a thin client system that is capable of designating and storing a long-term reference frame enabling the coding efficiency though a processing load can be hold down.

To accomplish the object given above, a server, to start with, sequentially generates screen data for displaying a screen on which to display a result of a process corresponding to operation information given from a terminal is displayed, and stores the data as short-term reference frames in the generating sequence in a first buffer. In the first buffer, when number of the short-term reference frames exceeds a predetermined number, the frames are discarded in the sequence from the oldest. On the other hand, the server detects, based on a message registered in a message queue of a GUI management program of an operating system, an activation event showing that an active window is switched over on the screen. When thus detecting the activation event, the server associates the latest short-term reference frame stored in the first buffer at that point of time with the window which is active at that point of time, and stores the short-term reference frame as a long-term reference frame in a second buffer. The long-term reference frame can be retained in the second buffer for a longer period of time than a retention period of the short-term reference frame in the first buffer. On the other hand, the server codes the thus-generated frames into a coded stream that can be decoded by a terminal in a way that refers to the most approximate frame in the individual short-term reference frames stored in the first buffer and the respective long-term reference frames stored in the second buffer, and transmits the coded stream to the terminal.

According to the configuration described above, the server can easily determine timing when the long-term reference frame should be registered on the basis of the message registered in the message queue of the GUI management program without executing complicated image processing of each of the frames of the image data, as a result, even when the initial window returns again to an active status after the active window has been switched over to a different window from a certain window, the last frame in a period for which the window was initially kept active is stored as the long-term reference frame in the second buffer, the long-term reference frame has a high possibility of being approximate to a coding target frame, and hence the frame can be coded at high efficiency simply by referring to the long-term reference frame.

The coding algorithm described above may be H.264 moving picture coding and may also be MPEG-4 (Moving Picture Experts Group phase 4). In short, a requirement may be such that a frame-to-frame difference is coded by the algorithm. Further, a capacity of the second buffer does not need being infinite and can be set smaller than a capacity of the first buffer. As a matter of course, in the case of reducing the capacity of the second buffer, a possibility is that the second buffer might be full of the frames according as the active window is repeatedly switched over. In such a case, a thinkable measure is an option of deleting the long-term reference frames already stored in the second buffer or an option of stopping, if such a possibility is low that the long-term reference frame to be newly stored will be referred to in the future, the storage thereof. It is considered that the former optional measure involves, for example, deleting the old long-term reference frame, deleting the long-term reference frame showing the minimum area of the associated active window, or deleting the existing long-term reference frame associated with the same window as the active window among the long-term reference frames to be newly stored. As the latter optional measure, it is adoptable to stop storing a long-term reference frame to be newly stored into the second buffer, for example, if the area of the active window in the long-term reference frame is smaller than a predetermined threshold value, if an aspect ratio of the active window is larger than a predetermined threshold value, or if an update frequency of the active window is larger than a predetermined threshold value.

Note that when using the H.264 moving picture coding as the coding algorithm, a reference list needs to be generated. In this case, if a pointer to a reference target frame is registered on the head side of the list, information for specifying a listing order thereof can be coded at high efficiency. Such being the case, a thinkable scheme includes, for instance, registering the pointer to the long-term reference frame stored in the second buffer in a position vicinal to the head with associated with the window switched over to an active status due to an activation event, registering the pointer in a position closer to the head as the area of the associated active window becomes larger, or registering the pointer in a position more proximal to the head as the pointer is associated with the window that is kept active more recently.

According to the present invention having the configuration described above, the long-term reference frame enabling the coding efficiency to be increased can be designated and stored though a processing load is kept low.

### DESCRIPTION OF THE ACCOMPANYING DRAWINGS

FIG.1 is a block diagram illustrating hardware configurations of a server machine and a thin client terminal which build up a thin client system.

FIG.2 is a block diagram illustrating a correlation of functions realized inwardly of the server machine and the thin client terminal.

FIG. 3 is a flowchart illustrating a flow of information between respective blocks illustrated in FIG. 2.

FIG.4 is a diagram illustrating long-term reference management information.

FIG. 5 is a flowchart illustrating a process executed when receiving the frame of GUI screen data.

FIG. 6 is a flowchart illustrating a reference list generation processing subroutine executed in S002 of FIG. 5.

FIG. 7 is a flowchart illustrating a long-term reference alignment correcting subroutine executed in S105 of FIG. 6.

FIG. 8 is a flowchart illustrating a process executed when receiving window information.

FIG. 9 is a diagram illustrating conceptually a list structure in a reference list.

FIG. 10 is a diagram exemplifying a correlation between occurrence of an activation event and registration of each reference frame.

FIG. 11 is a diagram illustrating a thin client system in the prior art.

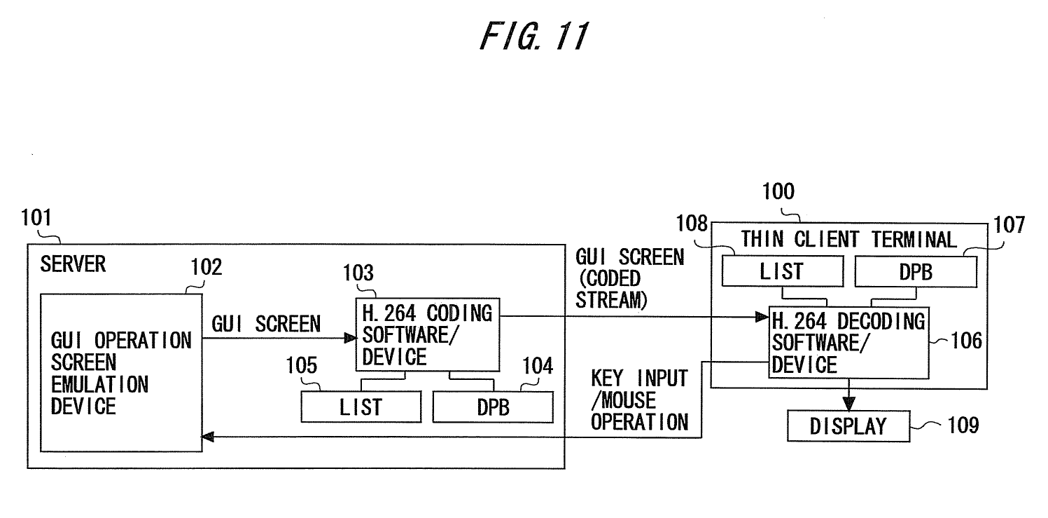

FIG. 12 is a diagram illustrating conceptually a DPB and a reference list in the prior art.

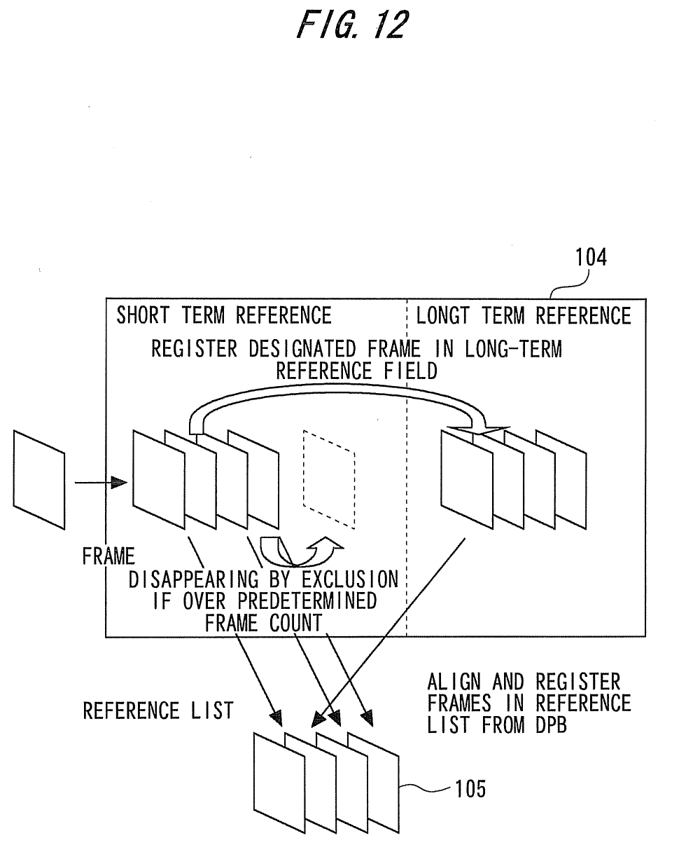

### DESCRIPTION OF THE PREFERRED EMBODIMENTS

An embodiment of an image coding method in a thin client system according to the present invention will hereinafter be described based on the drawings.

### <System Architecture>

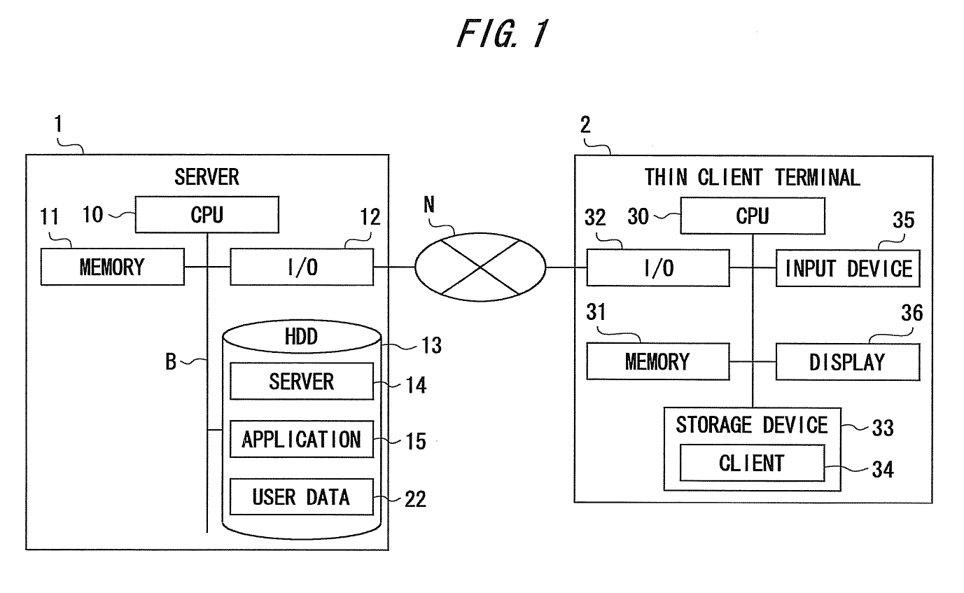

FIG. 1 is a schematic diagram illustrating the system architecture of the thin client system in which the image coding method is carried out. As illustrated in FIG. 1, the thin client system is configured by a server machine 1 and a plurality of thin client terminals 2 (of which only one terminal is illustrated in FIG. 1), which are connected to each other via a network N such as a LAN (Local Area Network).

The server machine 1 includes, as main components, a CPU 10, a memory 11, a communication interface 12 and a hard disk 13, which are connected to each other via a bus B.

The hard disk 13 is a disk device stored with various categories of programs and various items of data such as user data 22. The CPU 10 is a central processing unit, which executes the variety of programs stored in the hard disk 13. The memory 11 is a main storage device in which an operation area is developed when the CPU 10 executes the processes described above. The communication interface 12 is a device that terminates the network N and controls the communications via the network N.

On the other hand, the thin client terminal 2 includes, as main components, a CPU 30, a memory 31, a communication interface 32, a storage device 33, an input device 35 and a display 36, which are connected to each other via a bus B.

The storage device 33 is a disk device, which suffices for storing an operating system (OS) and a thin client program 25 at the minimum, and may also be a memory such as a ROM (Read-Only Memory) as well as being a hard disk. The CPU 30 is a central processing unit that executes various categories of programs stored in the storage device 33. The memory 31 is a main storage device in which the operation area is developed when the CPU 30 executes the processes described above. The communication interface 32 is a device which terminates the network N and controls the communications via the network N. The input device 35 is a pointing device such as a keyboard and a mouse, and inputs, when operated by an operator, pieces of operation information (about operation for keys of the keyboard and the mouse) showing a content of the operation to the CPU 30. The CPU 30 executes the thin client program 35, whereby the thus-inputted operation information is transmitted to the server 1. The display 36 displays, based on screen (picture) data organized by a series of frames decoded by an H.264 decoding software/device 39 which will be described later on, a moving picture on a screen for showing a processing result by the server 1.

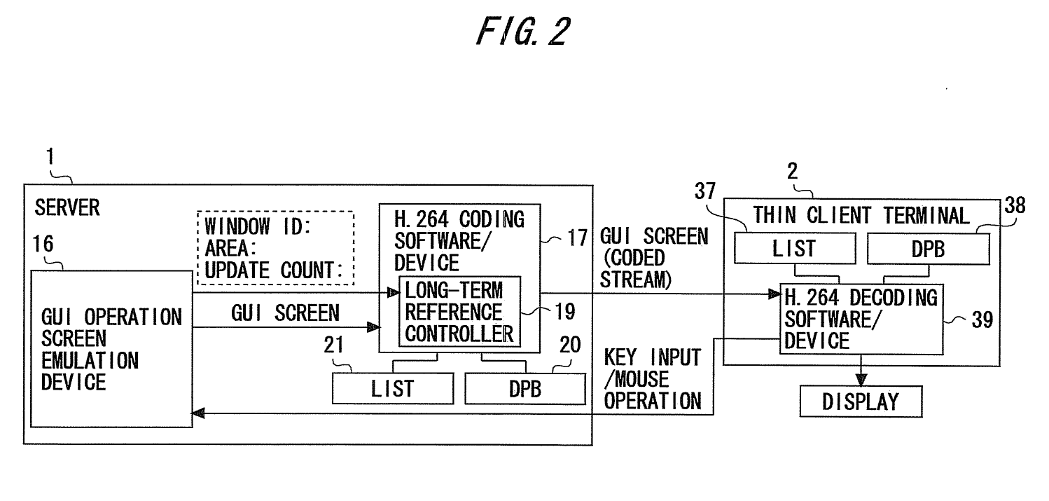

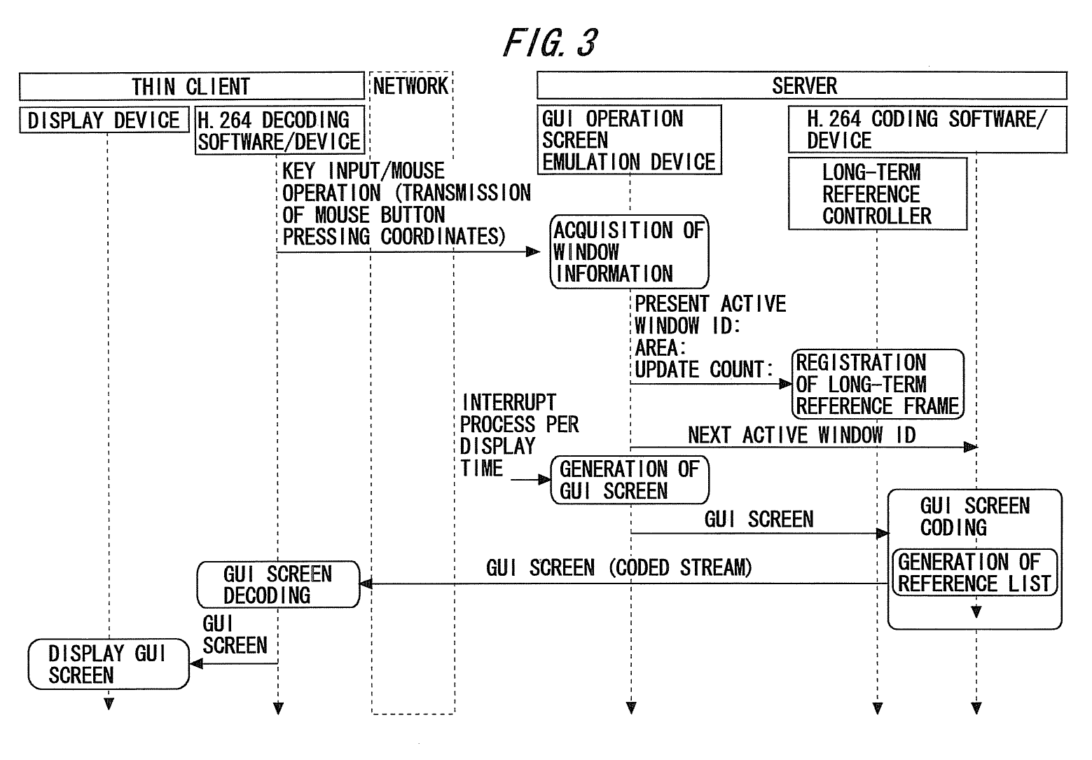

A program (or hardware substituted with a part of this program) stored in the hard disk 13 of the server 1 and the thin client program (or hardware substituted with a part of this program) stored in the storage device 33 of the thin client terminal 2, will hereinafter be described with reference to FIG. 2 illustrating blocks of functions related to the thin client system in the server 1 and FIG. 3 that is a flowchart illustrating how the data is transferred and received between the respective blocks in FIG. 2.

The variety of programs stored in the hard disk 13 of the server described above include a server program 14 and a multiplicity of application programs 15. The server program 14 is an operating system (OS) program (e.g., Citrix) Presentation Server™ of Citrix Systems, Inc., Java Station™ of Sun Microsystems, Inc., Windows Server Terminal Service™ of Microsoft Corp., etc) for making a computer building up the server machine 1 function as a server and making the server provide a thin client service. Accordingly, the server program 14 contains GUI (Graphical User Interface) operation screen emulation software and H.264 coding software.

The GUI operation screen emulation software makes the CPU 10 generate, at intervals of predetermined periods, frames of a GUI screen for displaying a processing result by a GUI-related module in the server program 14 or by the application program 15, which are executed based on the operation information (the information about operation for the keys and the mouse) received from the thin client terminal 2, and makes the CPU 10 hand the screen data thereof over to the H.264 coding software.

If the operation information (the information about operation for the keys and the mouse) received from the thin client terminal 2 represents an operation of switching over an active window, an activation event message (containing information showing window ID specifying the window becoming active) is registered in a message queue of a GUI management program in the server program 14, and hence the GUI operation screen emulation software gets the CPU 10 to detect the activation event registered in the message queue (which corresponds to activation event detecting part) and to hand over, to the H.264 coding software, items of information, i.e., window information such as an identification number (window ID) of the window that is active just when the activation event occurs, an area of the window and an update count representing how many times the window is updated.

Note that the function of the GUI operation screen emulation software can be also configured hardware. Thus, in FIGS. 2 and 3, the function realized by the GUI operation screen emulation software or hardware is described as a “GUI operation screen emulation device 16”.

Moreover, the H.264 coding software gets the CPU 10 to code the respective frames structuring the screen data that are transmitted from the GUI operation screen emulation software in a process according to the H.264 standards and to transmit a coded stream obtained in such a coding process to the thin client terminal 2 as a response.

To be specific, the H.264 coding software gets the CPU 10 to configure a DPB (Decoded Picture Buffer) 20 and a reference list 21 on the memory 11, to store, each time the individual frame is received, this received frame in a short-term reference field (which corresponds to a first buffer where the frames are discarded from the oldest when number of the retained short-term reference frame exceeds a predetermined number) in the DPB 20 (which corresponds to short-term reference frame registering part), to register a pointer thereof in the reference list 21. Further, the H.264 coding software gets the CPU 10 to copy the frame just when the activation event occurs into a long-term reference field (which corresponds to a second buffer capable of retaining a long-term reference frame for a longer period of time than the retention period of the short-term reference frame in the first buffer) in response to an instruction given from a long-term reference controller 18 that will be described later on (which corresponds to long-term reference frame registering part), to register a pointer of the copied frame in the reference list, thereafter, to segment the received frame into a plurality of macroblocks, to search for a reference frame in the DPB 20 in order from the frame having the smallest list number defined in the reference list 21 for every segmented macroblock, to specify a reference frame that is most approximate to the macroblock, and to code the macroblock with reference to the specified reference frame (which corresponds to coding means).

Along with this operation, the H.264 coding software gets the CPU 10 to request the thin client terminal 2 to send back information about which frame is stored as the long-term reference frame in the DPB 20, contents of the reference list 21 and further a coded stream (containing information showing which reference fame the respective macroblock of each frame is coded with reference to) acquired by the coding.

Note that the function of the H.264 coding software can be also configured as a hardware. Thus, in FIG. 2, the function realized by the H.264 coding software or hardware is described as an “H.264 coding software/device 17.” If the function of the H.264 coding software is configured as a hardware, the DPB 20 is constructed as a dedicated buffer, and the reference list 21 is structured on a rewritable memory comprising the hardware component.

Moreover, the H.264 coding software/device 17 has a built-in long-term reference control unit 19 as a special element that is not specified in H.264. The long-term reference control unit 19 may be configured as a program executed by the CPU 10 and may also be configured hardwarewise.

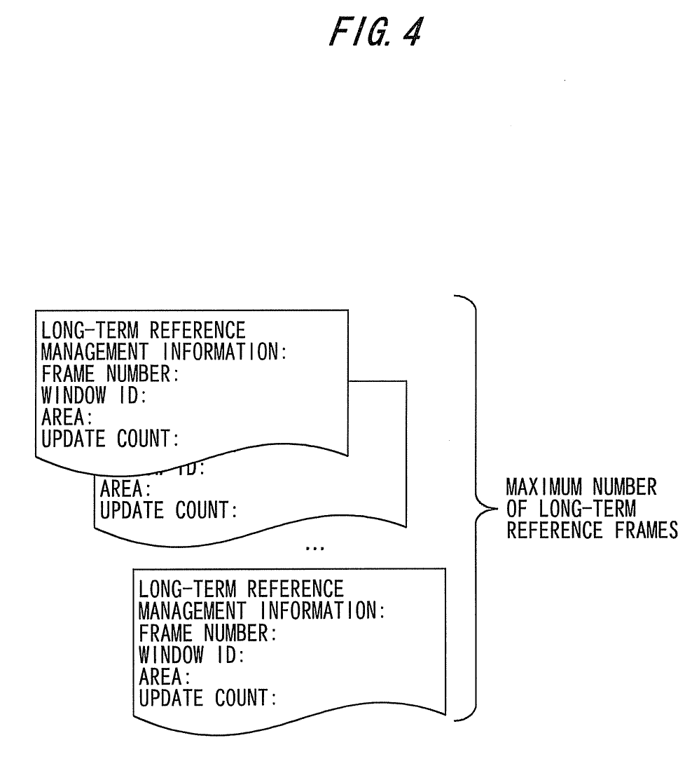

The long-term reference control unit 19 generates long-term reference management information having a structure as illustrated in FIG. 4 by referring to window information received from the GUI operation screen emulation device 16, and stores the long-term reference management information in the memory 11 if the long-term reference control unit 19 is configured as the program or in the hardware memory if configured as a hardware. A window ID, an area, an update count in the long-term reference management information are items of information taken over from the window information, and a frame number is an identification number of the frame just when the activation event occurs (i.e., the frame just anterior to the switchover of the active window). Incidentally, though the illustration is omitted, the long-term reference management information contains a description of information of the window (e.g., an aspect ratio) on the window, which is obtained from the GUI management program. Accordingly, the active window specified by the window ID is associated with the long-term reference frame specified by the frame number based on the long-term reference management information.

Then, the long-term reference control unit 19 instructs the H.264 coding software/device 17 to copy the target frame to the long-term reference field in the DPB 20 on the basis of the temporarily-stored long-term reference management information while restraining number of temporarily-stored long-term reference management information within a predetermined maximum number when the activation event occurs and to register the target frame in the reference list 21. Note that the long-term reference control unit 19 as a substitute for the GUI operation screen emulation software acquires the activation event from the message queue of the GUI management program.

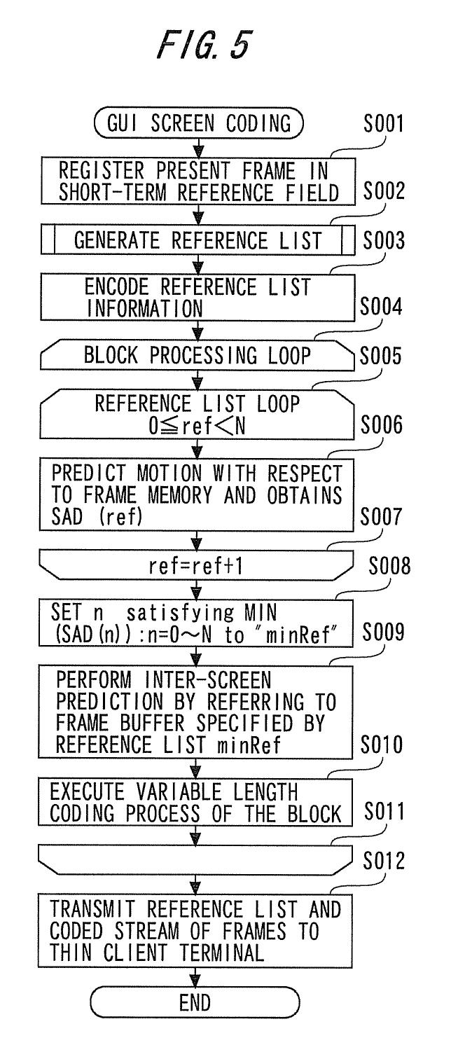

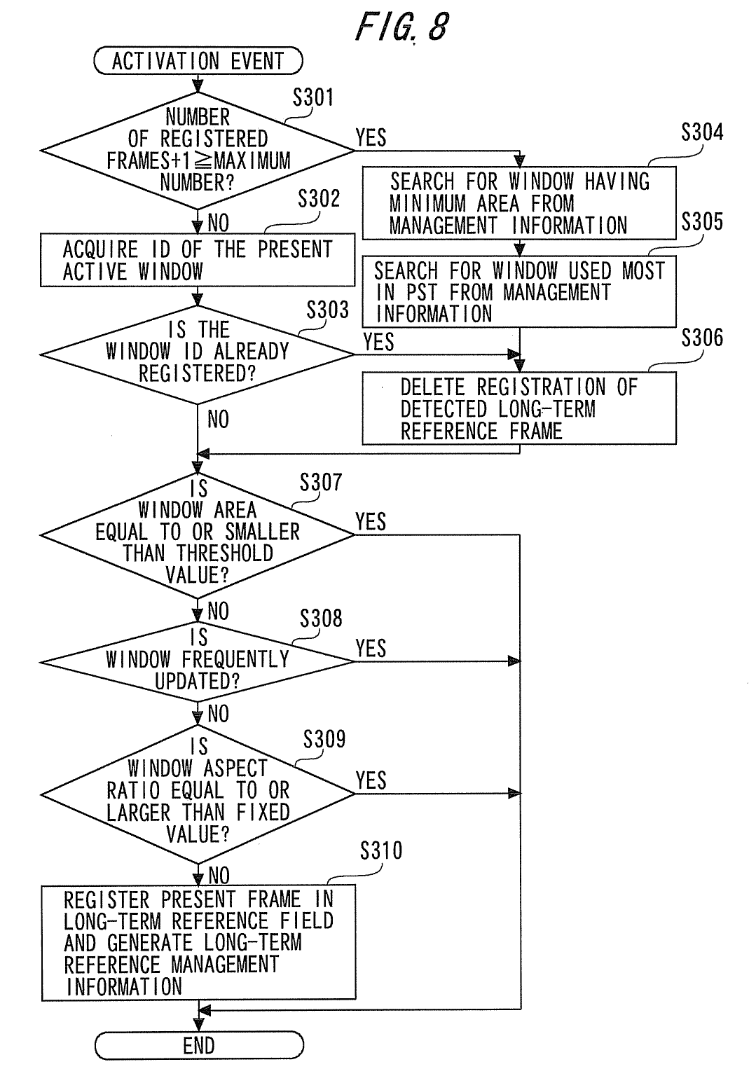

Specific contents of the processes executed by the H.264 coding software/device 17 including the long-term reference control unit 19 will hereinafter be described with reference to flowcharts in FIGS. 5 through 7 (which are the processes executed when receiving respective frame of the GUI screen data) and a flowchart in FIG. 8 (which are the process executed when receiving the window information).

To begin with, the process (which will hereinafter be referred to as a “GUI screen decoding process”) illustrated in the flowchart of FIG. 5 is started each time the individual frame of the GUI screen data is received from the GUI operation screen emulation device 16. Then, in first step S001 after the start, the H.264 coding software/device 17 stores the received frame of the GUI screen data as a short-term reference frame in the short-term reference field (which corresponds to short-term reference frame registering means) in the DPB 20.

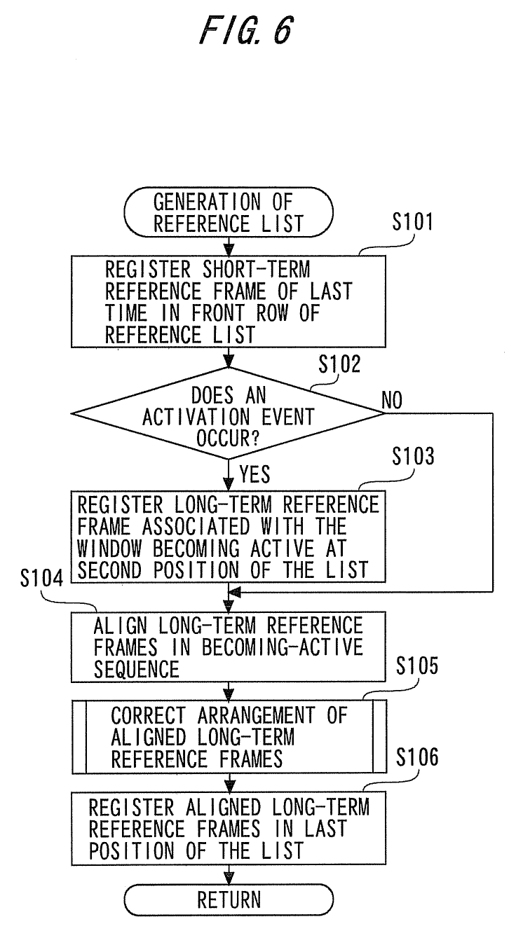

In next step S002, the H.264 coding software/device 17 executes a process of generating the reference list 21. Specifically, the H.264 coding software/device 17 executes the process based on a reference list generating process subroutine illustrated in FIG. 6.

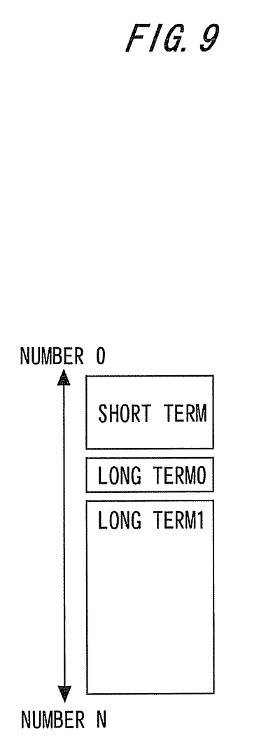

In first step S101 after entering this subroutine, the H.264 coding software/device 17, as illustrated in FIG. 9, registers the short-term reference frame stored in S001 in the GUI screen (picture) coding process of the last time, i.e., the pointer of the frame just anterior to the processing target frame in the head of the reference list.

In next step S102, it is checked whether the activation event occurs or not. This check is conducted based on whether or not a new piece of long-term reference management information described above is stored during a period till the GUI screen coding process of this time is started after the GUI screen coding process of the last time has been begun. Then, if the activation event does not occur, the H.264 coding software/device 17 advances the process to S104.

By contrast, if the activation event occurs, the H.264 coding software/device 17 registers, as illustrated in FIG. 9, in S103, the pointer of the long-term reference frame registered in the DPB 20 in a terminal phase of the period for which the window getting active due to the activation event was kept active in the past, in the second position of the reference list 21. Upon completion of S103, the H.264 coding software/device 17 advances the process to S104.

In S104, the H.264 coding software/device 17 aligns the pointers of the remaining long-term reference frames registered in the DPB 20 in the sequence from the latest in terms of the registration (which therefore represents the time when activated) thereof.

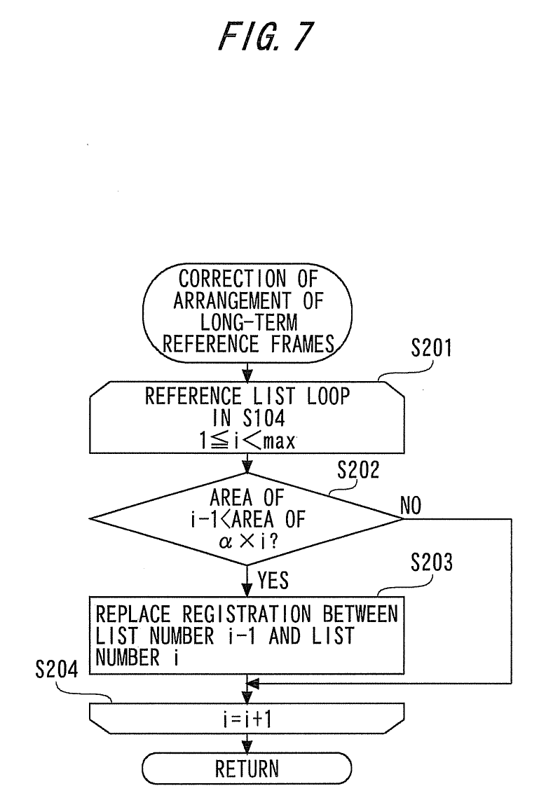

In next step S105, the H.264 coding software/device 17 corrects the aligning sequence, in the reference list 21, of the pointers of the long-term reference frames aligned in S104 on the basis of the area of the active window in the reference frames. To be specific, the H.264 coding software/device 17 executes a long-term reference alignment correcting subroutine illustrated in FIG. 7.

In the long-term reference alignment correcting subroutine, the H.264 coding software/device 17 executes a loop process in S201 through S204 for every pointer of each of the aligned long-term reference frames.

In first step S201 after entering this loop, the H.264 coding software/device 17 checks whether or not a variable i (of which initial value is 1) for designating the sequence of the aligned long-term reference frames is smaller than a reference value max (which is the same value of a total number of the existing long-term reference frames of which long-term reference frame management information exists if the process in S103 is executed but is a value larger by “1” than the total number of the long-term reference frames whereas if the process in S103 is not executed). Then, if equal to or larger than “1” but less than “max”, the H.264 coding software/device 17 checks in next step S202 whether or not a value obtained in a way that multiplies the area (the area in the long-term reference management information with respect to the long-term reference frame) of the active window frame pointed by an i-th pointer among the long-term reference frames by a predetermined constant α is smaller than the area of the active window pointed by an (i−1)th pointer among the long-term reference frame. Then, if the former area is equal to or larger than the latter area, the H.264 coding software/device 17 advances the process directly to S204. Note that in the case of the list number i=1, none of the comparative target exists, and hence the H.264 coding software/device 17 always advances the process to S204.

By contrast, if the former area is smaller than the latter area, the H.264 coding software/device 17 exchanges in S203 the order of the i-th pointer with the order of the i-th pointer in the reference list 21. Upon completion of S203, the H.264 coding software/device 17 advances the process to S204.

In S204, the H.264 coding software/device 17 increments the variable i by 1 and loops back the process to S201.

As a result of executing the loop of processes with respect to all of the long-term reference frame registered on the list, if the variable i is coincident with “max”, the H.264 coding software/device 17 terminates the long-term reference alignment correcting subroutine and returns the process to the routine in FIG. 6. Then, the H.264 coding software/device 17 advances the process to S106 from S105.

In S106, the H.264 coding software/device 17, as illustrated in FIG. 9, registers the pointers of the respective long-term reference frames aligned in S104 and corrected in terms of the alignment sequence in S105 in the last position of the reference list 21 in the order of their alignment sequence. When completing S106, the H.264 coding software/device 17 finishes the reference list generating process subroutine, and returns the process to the main routine in FIG. 5. Then, the H.264 coding software/device 17 advances the process to S003 from S002.

In S003, the H.264 coding software/device 17 codes the reference list generated in S002 by a method designated in H.264.

Subsequently, the H.264 coding software/device 17 segments the frame (which will hereinafter be termed a “processing target frame”) received this time from the GUI operation screen emulation device 16 into a plurality of macroblocks, and executes the loop of processes in S004 through S011 (a block processing loop) in order to perform coding for every macroblock.

In first step S004 after entering the block processing loop, the H.264 coding software/device 17 specifies one of the segmented macro blocks which have not yet processed as a processing target block. Subsequently, the H.264 coding software/device 17 executes the loop of processes in S005 through S007 with respect to the processing target block specified in S004 (a reference list loop).

In first step S005 after entering this reference list loop, the H.264 coding software/device 17 checks whether or not a variable ref (an initial value is “0”) is smaller than a constant N. Note that “ref” represents the list number associated with the pointer of the referring target reference frame. Specifically, ref=0 represents the list number of the short-term reference frame (i.e., the just-anterior frame) registered in the head position of the reference list 21, while ref=1 represents the list number of the long-term reference frame (i.e., the last frame, in case the activation event occurs just before the processing time, during the period for which the window switched over to the active status due to this activation event was kept active in the past) registered in the second position in the reference list 21, and hereinafter the value of ref indicates the list number of the long-term reference frame registered in a (ref+1) th position. Further, the constant N takes the same value as a value of the total number of the long-term reference frames.

The H.264 coding software/device 17, if the variable ref is smaller than N as a result of the check in S005, reads in S006 the pointer given the same list number as the value of the variable ref represents from the reference list 21, and further reads the reference frame from the frame memory in the DPB 20 that is pointed by this pointer. Then, the H.264 coding software/device 17 obtains a cumulative value “SAD (ref)” of a differential absolute value between the respective pixels contained in the processing target block and their corresponding pixels in the same position in the reference frame.

In next step S007, the H.264 coding software/device 17 increments the variable “ref” by 1 and loops back the process to S005.

As a result of repeating the reference list loop described above with respect to all of the reference frames, when the variable ref reaches the constant N, the H.264 coding software/device 17 exits the reference list loop and advances the process to S008.

In S008, the H.264 coding software/device 17 specifies, as “minRef”, a value of “ref” with which the cumulative value SAD (ref) calculated in S006 is minimized.

In next step S009, the H.264 coding software/device 17 reads from the reference list 21 the pointer given the same list number as the value of “minRef” represents and further reads the reference frame (i.e., the most approximate frame) from the frame memory in the DPB 20 that is pointed by this pointer. Then, the H.264 coding software/device 17 refers to the readout reference frame and performs an inter-screen prediction with the processing target block according to H.264.

In next step S010, the H.264 coding software/device 17 executes, based on a result of the inter-screen prediction in S009, a variable length coding process for the processing target block according to H.264, thereby acquiring the coded stream for the processing target block (which corresponds to coding means). Moreover, the H.264 coding software/device 17 codes “minRef” specified in S008 in the variable length coding process. At this time, a code length becomes shorter as “minRef” gets more approximate to “0”, in the process in S002 described above. the pointer of the important reference frame having a large possibility of being referred is disposed in the front position in the reference list 21, and hence the coding process is advantageous. Then, the H.264 coding software/device 17 adds the coded “minRef” as the information for specifying the referring target reference frame to the coded stream.

In next step S011, the H.264 coding software/device 17 loops back the process to S004.

After finishing executing the block processing loop described above with respect to the whole macroblocks, the H.264 coding software/device 17 exits the block processing loop and advances the process to S012.

In S012, the H.264 coding software/device 17 transmits the reference list coded in S003 and the coded stream generated in S010 to the H.264 decoding software/device 39 of the thin client terminal 2.

Through the operation described above, the GUI screen decoding process for one frame of the GUI screen data received from the GUI operation screen emulation device 16 is completed.

Next, a start of the process (which will hereinafter be referred to as an “activation event process”) illustrated in a flowchart of FIG. 8 is triggered by receiving the window information from the GUI operation screen emulation device 16. Then, in first step S301 after the start, the H.264 coding software/device 17 checks whether or not a value obtained by adding one to a number of pieces of long-term reference management information (number of pieces of registered information) stored in the memory 11 or the memory in the hardware at the present is equal to or larger than a predetermined maximum number. Then, the H.264 coding software/device 17 advances the process to S302 if the former is less than the latter and advances the process to S304 if the former is equal to or larger than the latter.

In S302, the H.264 coding software/device 17 acquires the window ID of the present active window (i.e., the window that is active just when the activation event occurs from the newly received window information.

In next step S303, the H.264 coding software/device 17 checks whether or not the window ID acquired in S302 has already been registered. To be specific, the H.264 coding software/device 17 checks whether or not the long-term reference management information containing the same window ID has already been stored in the memory 11 or in the memory in the hardware. Then, the H.264 coding software/device 17 advances the process to S306 if the long-term reference management information has already been stored (registered) and advances the process to S307 if not yet stored (registered).

On the other hand, the H.264 coding software/device 17 searches for the information showing the minimum “area (the area of the active window)” from the long-term reference management information already stored in the memory 11 or in the memory in the hardware.

In next step S305, the H.264 coding software/device 17 searches for the oldest long-term reference management information, i.e. the long-term reference management information containing the active window that shows the oldest generation period from pieces of long-term reference management information already stored in the memory 11 or in the memory in the hardware. After completing S305, the H.264 coding software/device 17 advances the process to S306.

In S306, the H.264 coding software/device 17 deletes, from the memory 11 or in the memory in the hardware, the long-term reference management information having the minimum “area (the area of the active window)” detected in S304 and the long-term reference management information detected in S305 or the long-term reference management information containing the window ID determined to be already registered in S303, and also deletes the long-term reference frames corresponding to the deleted long-term reference management information from the long-term reference frame field of the DPB 20. Upon completion of S306, the H.264 coding software/device 17 advances the process to S307.

In S307, the H.264 coding software/device 17 acquires the area of the present active window (i.e., the window that is active just when the activation event occurs) from the newly-received window information, and compares the area with a predetermined threshold value. Then, if the area of the window is equal to or smaller than the threshold value, the H.264 coding software/device 17, without registering the long-term reference frame at all, immediately finishes the activation event process. Whereas, if the area of the window exceeds the threshold value, the H.264 coding software/device 17 advances the process to S308.

In S308, the H.264 coding software/device 17 acquires a value of the update count of the present active window (i.e., the window that is active just when the activation event occurs) from the newly-received window information, and compares the value of the update count with a predetermined threshold value. Then, if the value of the update frequency is equal to or smaller than the threshold value, the H.264 coding software/device 17, based on an assumption that this window is frequently updated, without registering the long-term reference frame at all, immediately finishes the activation event process. Whereas if the value of the update frequency exceeds the threshold value, the H.264 coding software/device 17 assumes that this window is not frequently updated and advances the process to S309.

In S309, the H.264 coding software/device 17 acquires an aspect ratio of the present active window (i.e., the window that is active just when the activation event occurs) from the GUI management program, and compares the aspect ratio with a predetermined threshold value. Then, if the aspect ratio of the window is equal to or smaller than the threshold value, the H.264 coding software/device 17, without registering the long-term reference frame at all, immediately terminates the activation event process. Whereas if the aspect ratio of the window is less than the threshold value, the H.264 coding software/device 17 advances the process to S310.

In S310, the H.264 coding software/device 17 copies the latest short-term reference frame registered in the short-term reference frame field of the present DPB 20 to the long-term reference frame field (which corresponds to long-term reference frame registering means), then generates the long-term reference management information based on the contents of the newly-received window information, the frame information of the reference frame and the information on the window that is obtained from the management program, and stores the thus-generated long-term reference management information in the memory 11 or in the memory in the hardware. When completing S310, the H.264 coding software/device 17 completes the process of registering the long-term reference frame at the time the activation event occurs.

The thin client program 34 stored in the storage device 33 of the thin client terminal 2 is exemplified by Presentation Server Client™ of Citrix Systems, Inc., Java Virtual Machine™ of Sun Microsystems, Inc. and Remote Desktop Protocol™ of Microsoft Corp., and includes the H.264 decoding software. The H.264 decoding software gets the CPU 30 to generate the moving picture data of the GUI screen constructed of the series of frames by decoding the coded stream received from the H.264 coding software (the H.264 coding software/device 17) and to display the moving picture of the GUI screen based on the moving picture data on the display 36.

Specifically, the H.264 decoding software gets the CPU 30 to configure the DPB 38 and the reference list 37 described above on the storage device 33, to refer to the DPB 38 and the reference list 37 each time the CPU 30 receives the coded stream about each frame from the H.264 coding software/device 17, to decode the image data of the target frame on the basis of the information showing which reference frame the target frame is coded with reference to and the coded stream of the target frame, to display the thus-decoded image data on the display 36, and to store the decoded frame in the short-term reference frame field of the DPB 38. Further, the H.264 decoding software, when receiving the information showing which frame is stored as the long-term reference frame in the DPB 20 from the H.264 coding software/device 17, gets the CPU 30 to copy the frame specified by the information to the long-term reference frame field from the short-term reference frame field. Moreover, the H.264 decoding software, when receiving the contents of the reference list 21 from the H.264 coding software/device 17, gets the CPU 30 to update the reference list 37 as the contents are described. Thus, it is feasible to refer to the short-term reference frame or the long-term reference frame and the updated reference list that are stored in the DPB 38 in order to decode the frames from the next time onwards.

Note that the function of the H.264 decoding software can be configured by a hardware. Such being the case, in FIG. 2, the function realized by the H.264 decoding software or the hardware is described as an “H.264 decoding software/device 39”. If the function of the H.264 decoding software is configured by a hardware, the DPB 38 described above is constructed as a dedicated buffer, and the reference list 37 is structured on the rewritable memory constructing the hardware.

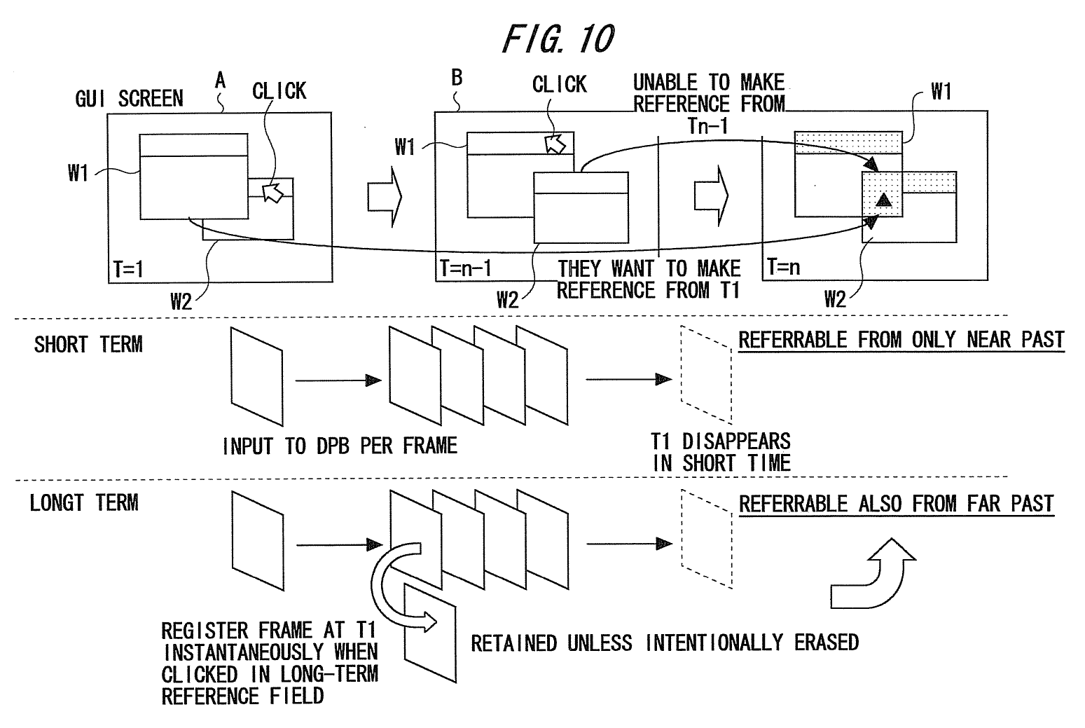

A flow showing operation for displaying the screen on the display 36 of the thin client terminal 2 by the thus-configured thin client system according to the embodiment, will hereinafter be described in accordance with an example in FIG. 10.

Now, it is supposed that the GUI screen (picture) illustrated by “A” in FIG. 10 is displayed on the display 36 with the coded stream transmitted from the server 1 on the basis of the operation of the input device 35 of the thin client terminal 2. On this GUI screen, a window W1 is active and partially overlapped with a non-active window W2. In this state, it follows that the GUI operation screen emulation device 16 periodically generates the frames of the items of screen data representing results of executing the server program 14 and the application program corresponding to the window W1 and representing a content of the operation (of a cursor etc) specified by the operation information, and transfers the frames to the H.264 coding software/device 17. The H.264 coding software/device 17 sequentially stores the thus-generated frames of the image data in the short-term reference frame field of the DPB 20, generates the reference list 21, then refers to and codes the short-term reference frame (i.e., the short-term reference frame received one before) with the pointer registered in the head position of the reference list 21, and transmits the resultantly-acquired coded stream to the thin client terminal 2. The H.264 decoding software/device 39 in the thin client terminal 2 decodes the frames of the series of screen data from the series of coded streams received, and displays based on the decoded frames the GUI screen shown by “A” in FIG. 10 as a moving picture.

At this point of time (T=1), an assumption is that the operator of the thin client terminal 2 performs an operation of switching over the window W2 to the active status by clicking with the mouse included in the input device 35. Then, the operation information is transmitted to the server 1 and is processed by the server program 14. Specifically, the server program 14 registers the activation event, by which the window W2 becomes active, in the message queue of the GUI management program.

The GUI operation screen emulation device 16, when detecting the activation event from the message queue, acquires the window information consisting of the window ID, the area and the update count of the window W1 kept active in the frames with respect to the screen data frames generated last time at that point of time (T=1), and notifies the H.264 coding software/device 17 of the window information. The H.264 coding software/device 17, upon receiving the window information, copies the short-term reference frame registered in the DPB 20 finally at this point of time as the long-term reference frame to the long-term reference frame field of the DPB 20.

When reaching the timing of the predetermined period immediately after that operation, the GUI operation screen emulation device 16 generates the frame for displaying the GUI operation screen on which the window W2 switched over to the active status is overlapped with the window W1, and transfers this frame to the H.264 coding software/device 17. Then, the H.264 coding software/device 17 stores the received frame in the short-term reference frame field of the DPB 20, and generates the reference list 21. Subsequently, the H.264 coding software/device 17 codes the received frame by referring to the reference frames in the DPB 20 that are pointed by the respective pointers in the sequence of their being registered in the reference list 21. Hereafter, the GUI operation screen emulation device 16 periodically generates the screen data frames representing the results of executing the server program 14 and the application program corresponding to the window W2 and representing the content of the operation (of the cursor etc) specified by the operation information, while the H.264 coding software/device 17 sequentially stores the generated frames in the short-term reference frame field of the DPB 20, and codes each frame by referring to the reference list 21 while generating the reference list 21. Based on the coded stream acquired by this coding, the H.264 decoding software/device 39 in the thin client terminal 2 displays the GUI screen shown by “B” in FIG. 10 as the moving picture. As described above, the short-term reference frames are sequentially stored in the short-term reference frame field of the DPB 20, and, along with this sequential storage, the old short-term reference frames are discarded by overwriting, with the result that the short-term reference frames showing “T=1” disappear from the short-term reference frame field within a short period of time. It follows, however, that the long-term reference frame copied from the short-term reference frame showing “T=1” is, as far as not erased in S306, retained for a longer period of time than the retention time of the short-term reference frame.

Thereafter, the assumption is that the operator of the thin client terminal 2 performs the operation of switching over the window W1 to the active status by clicking with the mouse included in the input device 35. Then, the GUI operation screen emulation device 16 detects the activation event from the message queue, and, in the same away as described above, notifies the H.264 coding software/device 17 of the window information, while the H.264 coding software/device 17 copies the short-term reference frame registered in DPB 20 just anterior thereto (T=n−1) to the long-term reference frame field of the DPB 20.

When reaching the timing (T−n) of the predetermined period immediately after that operation, the GUI operation screen emulation device 16 generates the frame for displaying the GUI operation screen on which the window W1 switched over to the active status is overlapped with the window W2, while the H.264 coding software/device 17 stores the frame in the short-term reference frame field of the DPB 20, and generates the reference list 21 in which the pointer of the short-term reference frame showing “T=n−1” is registered in the head position, and the pointer of the long-term reference frame copied to the long-term reference frame field of the DPB 20 at the terminal period (T=1) for which the window W1 switched over to the active status due to the activation event was active in the past, is registered in the second position. Then, the H.264 coding software/device 17 codes the received frame in a way that refers to the reference frames in the DPB 20, which are pointed by the individual pointers, in the sequence of their being registered in the reference list 21. At this time, the block of the region where the window W1 is superposed on the window W2 can not be coded at high efficiency even by referring to the short-term reference frame showing “T=n−1” with the pointer registered in the head position of the reference list 21. In the long-term reference frame showing “T=1” with the pointer registered in the second position, however, the window W1 is superposed on the window W2, and hence the frame showing “T=n” can be coded at the high efficiency by referring to the block of the superposed region.

As discussed above, according to the thin client system in the embodiment, the switchover of the active window on the GUI screen is detected based on the message of the activation event registered in the message queue of the GUI program, and the short-term reference frame stored in the short-term reference frame field of the DPB 20 just anterior thereto is copied to the long-term reference frame field, thereby eliminating the necessity for registering the complicated image processing for registering the long-term reference frame.

Further, in the processes in S303 and S306, in the case of registering the frame, in which a certain window is active, as the long-term reference (frame), if the older frame with the same window kept active is stored in the long-term reference frame field, the latter frame having no necessity of making the reference any more is deleted, and it is therefore feasible to prevent such a trouble that an unnecessary long-term reference frames stay in the DPB 20.

Further, on the occasion of registering a certain frame as the long-term reference (frame) through the process in S307, if the area of the active window in the frame is equal to or smaller than the predetermined threshold value, the registration thereof is omitted, and hence it is possible to prevent the frame, with respect to the window that can not be desired for coding at the high efficiency even when making the reference because of being narrower than the area of the macroblock, from being registered as the long-term reference frame with futility.

Moreover, through the process in S308, on the occasion of registering a certain frame as the long-term reference (frame), if the active window in the frame is frequently updated, the registration thereof is omitted, so that it is possible to prevent the frame, with respect to the window that can not be desired for coding at the high efficiency even when making the reference because of being already old in terms of the contents, from being registered as the long-term reference frame with the futility.

Furthermore, through the process in S309, on the occasion of registering a certain frame as the long-term reference (frame), if the aspect ratio of the active window in the frame is equal to or larger than the predetermined threshold value, the registration thereof is omitted, so that it is feasible to prevent the frame, with respect to the window that can not be desired for coding at the high efficiency even when making the reference because of being narrower than the area of the macroblock, from wastefully being registered as the long-term reference frame.

Still further, through the processes in S301, S304 and S306, if number of the long-term reference frames stored in the DPB 20 exceeds the maximum number, there is deleted from the DPB 20 the long-term reference frame with respect to the active window that can not be desired for coding at the high efficiency as described above because of the area being small, it is possible to store the new long-term reference frame having a high possibility of being referred to.

Yet further, through the processes in S301, S305 and S306, if the number of the long-term reference frames stored in the DPB 20 exceeds the maximum number, there is deleted from the DPB 20 the long-term reference frame with respect to the window that became active at the oldest past time but can not be desired for coding at the high efficiency because of the contents being old, it is feasible to store the new long-term reference frame having the high possibility of being referred to.

Additionally, through the process in S103, the long-term reference frame at the point of time when the window switched over to the active status due to the activation event was active in the past is registered in the second position of the reference list, and it is therefore feasible to code the information for specifying the long-term reference frame becoming the reference target frame at the high efficiency.

Moreover, through the process in S104, the long-term reference frame about the window, which was most recently active, is registered in the position closest to the head of the reference list, and hence it is possible to code the long-term reference frame becoming the reference target frame at the high efficiency.

Moreover, through the process in S105, the long-term reference frame about the active window having the smallest area is registered in the position closest to the head of the reference list, and hence it is feasible to code the long-term reference frame becoming the reference target frame at the high efficiency.

What is claimed is:

1. An image coding method in a thin client system, for generating screen data for displaying a screen on which a result of a process corresponding to operation information given from a terminal is displayed in a server, for coding the screen data into coded stream that can be decoded by said terminal and for transmitting the coded stream to said terminal,
said server executing steps of:
storing each of the frames of the screen data as a short-term reference frame in a generating sequence in a first buffer from which the retained short-term reference frames are discarded from the oldest when number of frames of the short-term reference frames exceeds a predetermined number;
detecting an activation event representing switchover of an active window in the screen on the basis of a message registered in a message queue of a GUI management program of an operating system;
storing the latest short-term reference frame stored in said first buffer at a point of time when the activation event is detected as the long-term reference frame in a second buffer capable of retaining long-term reference frames for a longer period of time than a retention period of the short-term reference frame in said first buffer, with the frame associated with a window that is active at the same point of time; and
coding each of the frames of the generated screen data by referring to the most approximate frame among the short-term reference frames stored in said first buffer and the long-term reference frames stored in said second buffer.

2. An image coding method in a thin client system according to claim 1, wherein said server codes each of the frames of the screen data on the basis of H.264 moving picture coding with reference to the most approximate frame in the most approximate frame in the short-term reference frames stored in said first buffer and the long-term reference frames stored in said second buffer.

3. An image coding method in a thin client system according to claim 1, wherein said server deletes the long-term reference frame associated with a closed window from said second buffer when the activation event represents that the window kept active on the screen is closed while a different window is switched over to an active status.

4. An image coding method in a thin client system according to claim 1, wherein said server deletes, if said second buffer is stored with a long-term reference frame associated with the same window as the latest short-term reference frame stored in said first buffer at the point of time when the activation event is detected, the long-term reference frame from said second buffer.

5. An image coding method in a thin client system according to claim 1, said server, if an area of the active window in the latest short-term reference frame stored in said first buffer is equal to or smaller than a predetermined value at the point of time when the activation event is detected, does not store the short-term reference frame as the long-term reference frame in said second buffer.

6. An image coding method in a thin client system according to claim 1, wherein said server, if an update frequency of the active window in the latest short-term reference frame stored in said first buffer is equal to or larger than a predetermined value at the point of time when the activation event is detected, does not store the short-term reference frame as the long-term reference frame in said second buffer.

7. An image coding method in a thin client system according to claim 1, wherein said server, if an aspect ratio of the active window in the latest short-term reference frame stored in said first buffer is equal to or larger than a predetermined value at the point of time when the activation event is detected, does not store the short-term reference frame as the long-term reference frame in said second buffer.

8. An image coding method in a thin client system according to claim 1, wherein said server, if number of the long-term reference frames stored in said second buffer reaches a predetermined number at the point of time when the activation event, deletes, from said second buffer is detected, the frame having the minimum area of the associated window in the long-term reference frames stored in said second buffer.

9. An image coding method in a thin client system according to claim 1, wherein said server, if number of the long-term reference frames stored in said second buffer reaches the predetermined number at the point of time when the activation event is detected, deletes, from said second buffer, the oldest frame in the long-term reference frames stored in said second buffer.

10. A computer readable medium storing an image coding program which makes a computer generating screen data for displaying a screen on which a result of a process corresponding to operation information given from a thin client terminal is displayed in a server, codes the screen data into coded stream that can be decoded by said terminal and transmitting the coded stream to said terminal execute steps of:
storing each of the frames of the screen data as a short-term reference frame in a generating sequence in a first buffer from which the retained short-term reference frames are discarded from the oldest when a number of the short-term reference frames exceeds a predetermined number;
detecting an activation event representing switchover of an active window in the screen on the basis of a message registered in a message queue of a GUI management program of an operating system;
storing a latest short-term reference frame stored in said first buffer, at a point of time when the activation event is detected, as the long-term reference frame in a second buffer capable of retaining long-term reference frames for a longer period of time than a retention period of the short-term reference frame in said first buffer, with the frame associated with a window that is active at the same point of time; and
coding means coding each of the frames of the generated screen data by referring to the most approximate frame among the short-term reference frames stored in said first buffer and the long-term reference frames stored in said second buffer.
